(19) United States
(12) Patent Application Publication
(10) Pub. No.: US 2025/0118954 A1
(43) Pub. Date: Apr. 10, 2025

(54) Foam Sealant Ready Box

(71) Applicants: Wesley Daniel Schulte, Manchester, IA (US); Jason Nicholas Nolz, Manchester, IA (US)

(72) Inventors: Wesley Daniel Schulte, Manchester, IA (US); Jason Nicholas Nolz, Manchester, IA (US)

(21) Appl. No.: 18/910,220

(22) Filed: Oct. 9, 2024

Related U.S. Application Data
(60) Provisional application No. 63/629,310, filed on Oct. 10, 2023.

(51) Int. Cl. H02G 3/08

(52) U.S. Cl. CPC H02G 3/083

(57) ABSTRACT

An electrical box featuring an improved design that once installed in the stud cavity, allows for air sealing and insulation after the interior sheeting is completed and before final electrical installation. This enhanced electrical box is equipped to accept a spray foam sealant applicator into channels, enabling the transfer of foam sealant through the periphery of box into an enclosed and finished wall cavity. The foam sealant bonds the sheeting, insulation, and box into a single, airtight, and insulated component within the wall cavity.

### FIELD OF THE INVENTION

This invention pertains to electrical boxes used for mounting and securing receptacles, switches, and fixtures on walls or ceilings to facilitate proper wiring connections.

### BACKGROUND OF THE INVENTION

Existing electrical boxes present certain challenges and problems. Accordingly, there is a need for an improved electrical box design.

This invention pertains to electrical boxes, particularly those used for mounting and securing receptacles, switches, fixtures, and other electrical components in residential, commercial, and industrial environments. The invention addresses issues related to energy loss, improving the box's ability to maintain insulation integrity, reduce drafts, and enhance overall energy efficiency, while also focusing on air quality, safety, ease of installation, and durability.

### BRIEF SUMMARY OF INVENTION

The invention relates to an advanced electrical box designed for improved insulation, air sealing, and energy efficiency in building construction. This electrical box can be in various configurations such as rectangular, square, or round, includes key features to address energy loss and insulation challenges in wall cavities.

The invention is electrical junction box of any shape, which comprises
a box having a bottom wall, one or more sidewalls, and an open face opposing the bottom wall; the bottom wall and one or more sidewalls defining an interior space having a depth from the open face to the bottom,
one or more wire entry points through a sidewall or bottom wall; and
a boss positioned on the one or more sidewalls, the boss having a boss channel, the boss channel comprising a foam sealant dispenser receptacle having a front aperture open to the open face and a recessed screw receptacle exposed to the open face through the foam sealant dispenser receptable, wherein the boss channel is in fluid communication with an associated opening in the sidewall or the bottom wall, the boss channel defining a flow path from the foam sealant dispenser receptacle through the recessed screw receptacle and out of the box through the associated opening, and the front aperture of the foam sealant dispenser receptacle has a diameter larger than the diameter of the recessed screw receptacle.

The invention is also an electrical junction box of any shape, which comprises
a box having a bottom wall, one or more sidewalls, and an open face opposing the bottom wall; the bottom wall and one or more sidewalls defining an interior space having a depth from the open face to the bottom wall,
one or more wire entry points through a sidewall or bottom wall; and
a boss positioned on the one or more sidewalls, the boss having a boss channel, the boss channel comprising a foam sealant dispenser receptacle having a front aperture open to the open face and a screw receptacle exposed to the open face through the foam sealant dispenser receptable, wherein the boss channel is in fluid communication with an associated opening positioned on the sidewall at a distance from the open face of at least 25% of the depth of the box, the boss channel defining a flow path from the foam sealant dispenser receptacle through the screw receptacle and out of the box through the associated opening, wherein the associated opening in the sidewall is in fluid communication with a trough on an exterior side of the sidewall, the trough extending from the associated opening to the bottom of the box.

The invention is also a method of sealing an electrical junction box, comprising
a) fastening an electrical junction box of the invention onto a construction assembly such that the electrical junction box is at least partially surrounded by empty space;
b) introducing a flowable, curable foam sealant into the foam sealant dispenser receptacle and flowing the foam sealant through the boss channel and out of the associated opening into the empty space at least partially surrounding the electrical junction box, and
c) curing the foam sealant in the space surrounding the electrical junction box.

In addition, the invention is also a method of sealing an electrical junction box, comprising
a) fastening the electrical junction box onto a construction assembly mounted onto a construction assembly such that the electrical junction box is at least partially surrounded by empty space,
wherein the electrical junction box comprises a box having a bottom wall, one or more sidewalls, and an open face opposing the bottom wall; the bottom wall and one or more sidewalls defining an interior space having a depth from the open face to the bottom wall; one or more wire entry points through a sidewall or bottom; a boss positioned on the one or more sidewalls, the boss having a boss channel having a front aperture open to the open face, wherein the boss channel is in fluid communication with one or more associated openings in the sidewall or the bottom wall, the boss channel defining a flow path from the front aperture to the associated opening;
b) introducing a flowable, curable foam sealant into the boss channel through the front aperture and flowing the foam sealant through the boss channel and out of the associated opening into the empty space at least partially surrounding the electrical junction box, and
c) curing the foam sealant in the space surrounding the electrical junction box.

The electrical box adheres to industry standards, maintaining the existing internal shape of current boxes, while using standard components and parts, which are redesigned to enhance performance. It is an improved design with optional integrated foam sealant dispenser receptacles and extended channels to accommodate the application of expanding foam sealant. This foam sealant application enhances the box's ability to seal gaps and insulate the space around it within a wall cavity. The box includes precisely engineered bosses and channels that direct foam sealant to fill voids and create an airtight seal between the box, insulation, and wall sheeting within a wall cavity. The foam sealant dispenser receptacle is larger in diameter compared to standard screw receptacles, ensuring efficient foam sealant transfer. The box is equipped with wire knockouts for easy wire entry and is secured to wall studs or in ceilings using various attachment methods, such as nails or screws. It should be known that the term ‘Knockouts’ are used synonymously with doors, hinge, clamps, auto clamps, feeds to allow the easy penetration of wires into the box.

The innovative design includes an extended foam sealant transfer channel which enables the distribution of foam sealant in multiple directions, ensuring 100% coverage of the box and bonding of all materials surrounding it. The foam sealant application process is conducted after wall insulation and interior wall assembly, before the final electrical fixture installation, ensuring an effective air seal and insulation bond. This method prevents common issues such as air leakage, moisture infiltration, and energy loss due to improper insulation around electrical boxes.

In this improved design, we have retained the traditional shape and capacity of the existing electrical box, while incorporating innovative features that significantly enhances both insulation and vapor sealing performance. This advancement optimizes the box's functionality without altering its original form factor, ensuring compatibility with standard installations while delivering superior performance.

The key features of this invention optimize performance and box efficiency which require minimal additional materials during production, thereby maintaining a low cost of manufacturing.

Overall, the invention provides a robust solution for enhancing energy efficiency and maintaining indoor air quality by integrating advanced sealing and insulating features into the electrical box design.

### BRIEF DESCRIPTION OF SEVERAL VIEWS OF THE DRAWINGS

FIG. 1 illustrates present invention with fixture & mounting screw.

FIG. 2 illustrates a top view of the present invention.

FIG. 3 illustrates a cut-away view of an opposite end wall of the present invention.

FIG. 4 illustrates a view of the present invention with foam sealant can and dispenser.

FIG. 5 illustrates a top view of a round box of present invention.

FIG. 6 illustrates a side view of a round box of present invention.

### DETAILED DESCRIPTION OF THE INVENTION

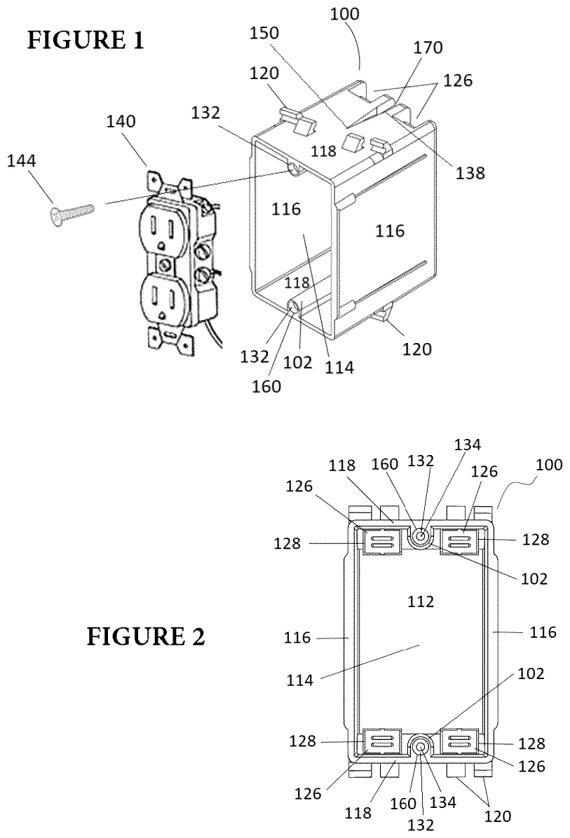

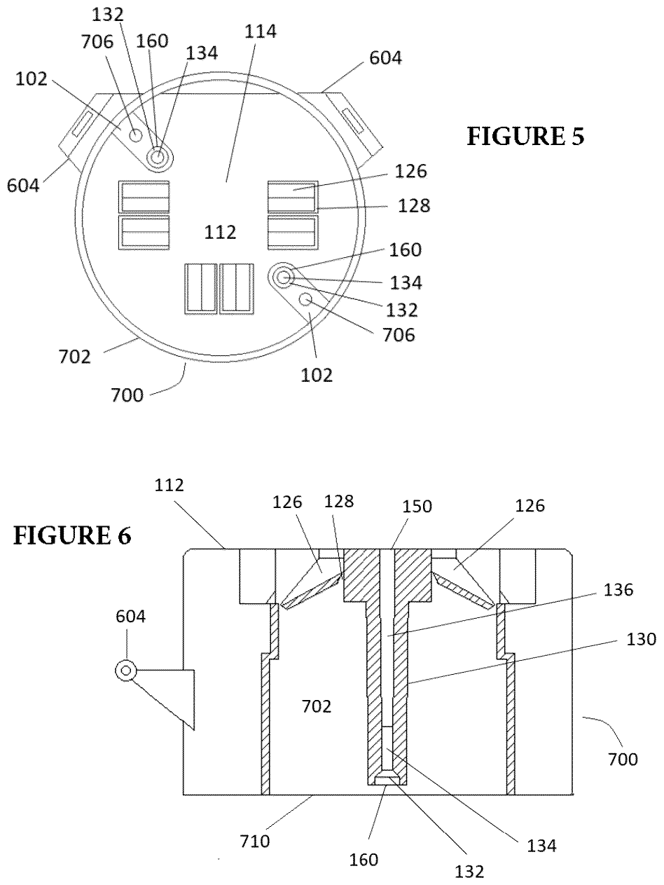

New and improved electrical junction box 100 of the invention is generally shown in FIGS. 1-4 to be rectangular in shape, however it may be any other convenient shape such as square, rectangle or round. It should be noted of its parts having a bottom wall 112, sidewalls including end sidewalls 118 and lateral sidewalls 116, and open face 114. Box 100 has a bottom defined by the exterior side of bottom wall 112. It should be noted the terms “end sidewalls” and “lateral sidewalls” are relative and may depend on direction or orientation of installation as it is interchangeable in the field. The invention also imagines round box embodiments with single continuous side walls 702, as shown in FIG. 5. In the particular embodiment shown in FIG. 1, bosses 102 are positioned symmetrically at opposite end sidewalls 118 and are a pre-determined distance apart to accommodate the pre-determined size of an electrical fixture 140. In the particular embodiment shown in FIGS. 1-4, each boss 102 includes a boss channel 130 which defines a flow path from open face 114 to opening 150 on the exterior side of the corresponding end sidewall 118. It should be known that when an electrical box is mounted in a corner of a wall cavity against two studs, only a single boss channel 130 is imagined. In the particular embodiment shown, each boss channel 130 includes front aperture 160, optional but preferred foam sealant dispenser receptacle 132, screw receptacle 134, which is preferably recessed from open face 114 (as shown), optional enclosed extended channel 136 and out of the box through the associated opening 160. Front aperture 160 of foam sealant dispenser receptacle 132 (when present) has a diameter larger than the diameter of screw receptacle 134.

It should be known that length of mounting fixture screw 144 may be, for example, 24/32″ (about 19 mm) or longer, having the full length screw contact the interior diameter of receptacle walls in a friction fit fashion would require greater installation force, installation problems and compromise the structural integrity of the box. In addition, with increased force and installation challenges, it increases the probability of deformation of mounting fixture screw 144. It should be known that the preferred length of screw receptacle 134 of box 100 preferably is no greater than 24/32″ (about 19 mm), such as from 8/32″ to 24/32″ (about 6.3 mm to 19 mm) and in a particular embodiment is 14/32″ (about 11 mm) as in industry standard boxes, to avoid increased force and installation challenges, stripping or deforming mounting fixture screw 144.

Box 100 as shown in FIGS. 1-4 is single gang box as indicated with a single pair of bosses 102, one at each end wall. It should be known that there are instances where a single boss channel 102 may be present. Round boxes are single gang only, however, such a round box may have multiple opposite end pairs of screw receptacles (such as shown in FIG. 5), which are an object of this invention. Each gang has the capability of securing a single electrical fixture 140. A single gang box is shown in FIG. 1, however the invention realizes two gang, three gang, 4 gang, 5 gang or any higher number of gang embodiments, in any shape and size including round boxes. Wire knockouts 126 are positioned at the four corners of bottom wall 112, however they may be located at the sidewalls 116 and/or 118 in some embodiments. Wire knockouts 126 are removable to allow the passage of wire into the box 100. Bosses 102 may maintain a cylindrical shape throughout the entire distance from open face 114 to bottom wall 112. In the embodiments shown, bosses 102 are mounted on an interior surface of end sidewalls 118 (and wall 702 in FIG. 5) and therefore occupy space inside the box 100, at each end wall 118 and in some embodiments have a greater diameter at the bottom of box 100 than at front face 114. Observation of boss 102 from outside box 100, reveals trough 138, rearward of boss channel 130, in fluid communication with opening 160, and which projects to the bottom of box 100.

Box 100 as shown in FIG. 1 is a single molded piece, however, box 100 could be made from separate molded parts and joined together to encompass the object of the invention. Box 100 can be made from a rigid polymeric material consistent with the industry that satisfies UL or other applicable standards for fire protection, strength and stability. Box 100 can be produced in different sizes in particular embodiments and is of different capacities dependent upon electrical codes and industry standards.

Box 100 in the embodiment shown in FIGS. 1-4 is adapted to secured to a wall stud by nails, which slide through nail flanges 120, which are secured at opposite end sidewalls 118. Boxes in other embodiments of the invention comprise brackets, side flanges or front facing flanges, as utilized in remodeling box applications, and/or other apparatus for affixing box 100 to a construction assembly.

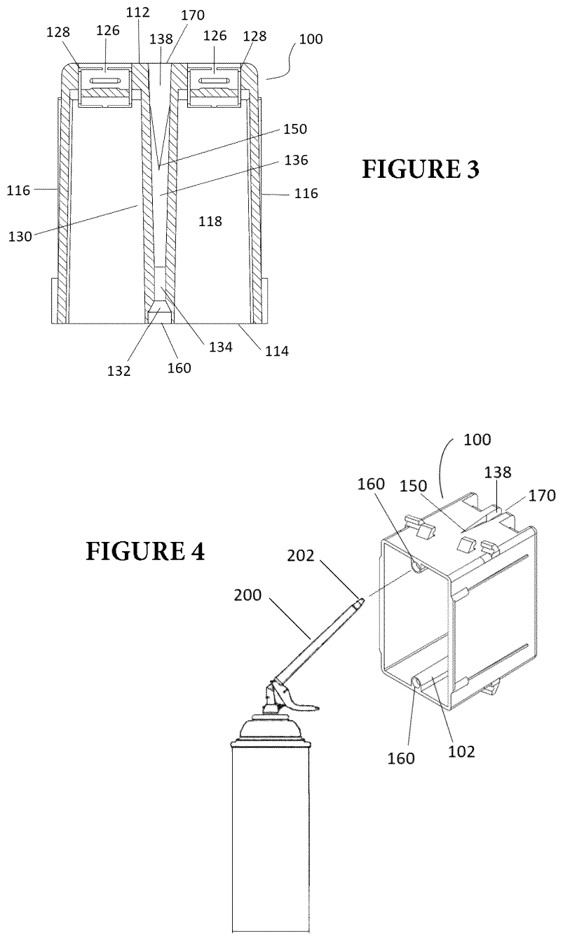

Referring to FIG. 3 illustrates an embodiment of an end sidewall 118 having of boss channel 130 shown partially in section. In this embodiment, bosses' channel 130 comprises optional foam sealant dispenser receptacle 132, screw receptacle 134, and optional enclosed foam sealant transfer channel 136, all three combine to form a continuous enclosed boss channel 130. Boss channel 130 is open to open face 114 of box 100 via front aperture 160 and open to an outside surface of end sidewall 118 via opening 150. In this embodiment, opening 150 in in fluid communication with trough 138 which extends to the bottom of box 100.

In the embodiment shown in FIGS. 1-4, trough 138 wherein the trough has a trough bottom 170 and is open to an exterior surface of end sidewall 188, and trough 138 is wider at the opening to the exterior surface of end sidewall 118 than at trough bottom 170, in this particular case having a. v-shaped cross-section. As shown, trough 138 has a width that increases from the associated opening to the bottom of the box. Such a trough design serves to allow foam sealant entering trough 138 from boss channel 130 to travel into multiple directions. This geometry of trough 138 increases the surface area at the point the foam sealant exits boss channel 100, with the foam sealant projecting upward through the opening 150 and rearward to the bottom of box 100. It should be clear that there is no obstruction or diversion of the foam sealant, only that the foam sealant is released multiple directions. As foam sealant exits boss channel 130 and enter trough 138, foam sealant will exit upwards through opening 150 and have more time to dissipate and travel multiple directions due to the greater surface area created by the shape of trough 138. The foam sealant that exits upward and downward from opening 150 Referring further to v shaped opening in embodiment 100 which may optionally not be utilized in other embodiments, as foam sealant exits boss channel 130 and enter trough 138, foam sealant will exit upwards through opening 150 and have more time to dissipate and travel multiple directions due to the greater surface area created by the shape of the exit point. The Foam sealant that exits upward and downward at the first outlet of the opening 150 will expand above and below the box.

In other embodiments boss channel 130 extends all the way to the bottom of box 100 is is open to the bottom, in which case a trough 138 would not be present. Foam sealant transfer channel 136 and opening 150 each preferably has an increased aperture greater than the that of the diameter of screw receptacle 134.

A box such as shown in FIGS. 1-4 may have standard dimensions of a nominally 18 cubic inch (295 cm³) box that measures 2¼ inches (5.7 cm) wide, 3% inches (9.53 cm) high and 2% inches (7 cm) deep. Although this is a typical size of a single gang box, box 100 may be deeper and may be wider to accommodate more fixtures.

Foam sealant dispenser receptacle 132 may have a front aperture 160 diameter open to open face 114 of, for example 6/32″ (4.75 mm) to 8/32″ (6.35 mm). A foam sealant dispenser 200 will be firmly positioned against foam sealant dispenser receptacle 132 to release and transfer a flowable, curable foam sealant through boss channel 130 for insulation and air sealing box 100. Foam sealant dispenser tip 200 is placed inside foam sealant dispenser receptacle 132 to maintain a seal and prevent foam sealant from spraying into box 100 or into living space. A proper seal would be difficult to achieve with a semi flat surface so foam sealant dispenser receptacle 132 should maintain a depth or internal space at the top of the box, while allowing screw receptacle channel 134 ample distance to effectively secure fixture 140 with a standard screw 144 that is 24/32″ (about 19 mm) in length. Foam sealant dispenser receptacle 132 preferably has a depth of 4/32″ (3 mm) to 16/32″ inches (12.7 mm), especially 4/32″ (3 mm) to 8/32″ (6.35 mm) or 6/32 (4.75 mm) to 8/32″ (6.35 mm), and may taper from front aperture 160 toward screw receptacle channel 134, as shown in FIGS. 1-4. In the embodiment shown in FIGS. 1-4, foam sealant dispenser receptacle 132 has a beveled structure with a front aperture 160 that custom fits a foam sealant applicator straw and a more tapered or conical section 132A to accommodate many different foam sealant applicator dispensers in other embodiments. Foam sealant dispenser tip 202 (FIG. 4) typically is 8/32″ to 4/32″ in diameter and would require a depth of 4/32″ for a tube applicator and from 6/32″ to 8/32″ for a conical shaped applicator.

Screw receptacle 134 is positioned rearward of foam sealant dispenser receptacle 132 in embodiment in which foam sealant dispenser receptacle is present. Foam sealant dispenser receptacle 132 may be omitted, for example, in cases in which screw receptacle 134 is large enough in diameter to insert disperser tip 200 directly into screw receptacle 134. Screw receptable 134 is a linear channel within boss channel 130 which is adapted to receive and hold a screw 144 of an electrical fixture 140. A typical diameter of screw receptacle is 4/32″ (3 mm) to 8/32″ (6.35 mm), especially 4/32″ (about 3 mm) to 6/32″ (4.75 mm) to accommodate the fastening mechanism of standardized screw 144. In embodiments where foam sealant receptacle 132 is absent, screw receptacle 134 starts at front aperture 160 of boss 102 and preferably has a length as described above. In typical embodiments, screw 144 generally has a predetermined or universal sized diameter of 6/32″ (about 4.75 mm) and a length of 24/32″ inches (about 19 mm) such as are included with electrical fixtures of many applications. It should also be noted that while electrical boxes and rounds may feature larger diameter screw receptacles, one objective of our invention is to provide a foam sealant dispenser receptacle with a larger diameter compared to the screw receptacle, along with an extended foam sealant transfer channel beyond screw receptacle to at least 25% and in some embodiments, extend all the way to bottom of box.

In one embodiment of the invention the bosses' channel illustrated in FIG. 3, foam sealant receptacle 132 is a length of 8/32″ (6.35 mm) and screw receptacle 134 has a length of 14/32″ (about 11 mm) the total length of the screw occupied portion of the bosses is 22/32″ (about 17.5 mm). In such an embodiment, the length of the standardized screw 144 is 24/32″ (about 17.5 mm) and is of sufficient length to secure the electrical fixture 140 to box 100.

Boss channel 130 preferably further includes foam sealant transfer channel 136, which extends rearward toward the bottom of box 100 from screw receptacle channel 134 as shown in FIG. 3. Foam sealant transfer channel 136 preferably increases in diameter throughout its path rearward or otherwise has a diameter greater than that of screw receptacle 134 to improve volume of foam sealant and ease of transfer, however other embodiments may maintain the same diameter as screw receptacle or even have a smaller diameter.

Boss channel 130 ends at opening 150. Opening 150 is located on the end sidewall at a distance from open face 114 of at least 25% of the depth of box 100. Boss channel 130 optionally can span the entire length to the bottom of box 100, opening 150 in such case being located in bottom wall 112 or the bottom end of end sidewall 118. Opening 150 in some embodiments is located at a distance from open face 114 of 50 to 90%, or 60-75% of the depth of box 100. It should be apparent that foam sealant dispenser receptacle 132, screw receptacle 134 and foam sealant transfer channel 136, form a continuous channel referred to as boss channel 130, which starts at the top of box 100 and ends from 25% of the depth of the box to 100% of the depth of the box depending on the embodiments of the invention. In embodiment of box 100, bosses 102 are flush with top of end walls 118 and in other applications, including round boxes, bosses 102 may be recessed from top 114.

Trough 138 assumes a v shape according to the embodiment shown in FIGS. 1-4, however, it should be known that other oval, round, square, rectangle or any shape perpendicular or close to right-angled are imagined as they will increase the surface area of the exit point as compared to a smaller diameter and perpendicular cut hole. Trough 138 extends to and is open to the rear of the box 100. In accordance with customary use of an electrical box, box 100 is attached to a a construction assembly; the particular embodiment shown in FIGS. 1-4 is adapted to be attached to a stud with nails that go through the nail flanges 120 that are attached at opposite end sidewalls 118; however other methods of attachment are imagined including screws, brackets plates and flanges, which should be known as fasteners. Box 100 is typically attached to a stud at a depth that provides for a flush finish with the interior finish drywall, paneling or sheeting.

During the rough-in electrical phase, wires must be routed and secured into the designated electrical boxes throughout the building structure. This process involves running the wiring through wall or ceiling cavities, either above, below or within the framing, and feeding it through the drilled holes in the studs until it reaches the specified location at box 100. The wire must be pulled into box 100 through the wire knockouts 126 to allow for fixture connections. After the wires are run through the studs and into box 100, the path of the wire must be stapled or attached to the studs at various points and within 12 inches of box 100, according to NEC standards. Sufficient wire length must be maintained inside the box to properly install the electrical fixture 140. Sufficient space is required in electrical boxes as established by electrical protocols and codes, thus box design efficiency is a benefit.

Exterior and Interior walls are customarily 2×4″ or 2×6″ construction. When box 100 is mounted to a stud and wire is stapled to the stud within 12 inches, wires must enter box at knockouts 126. Because wires must enter at the bottom 112 of box 100, and often enter from both above and below box 100 the wires must occupy space in the wall cavity intended for insulation. Insulation is then added to the wall cavity and is positioned around box 100. Fiberglass insulation has many microfibers that are in all directions and assumes the physical characteristics much like cotton candy. Fiberglass insulation relies on its ability to trap air and loses its benefits when the fibers are pushed together and are compressed. Box 100, when insulated with fiberglass insulation is totally encapsulated in a box type structure at its periphery. As fiberglass is cut to tightly mold around the box 100, it is important that box 100 is predictable in size and shape and is not distorted by added material, or compression of insulation would be evident. Furthermore, the wires that are traveling from studs to the box at different angles and locations into the center of the wall cavity at the box create voids, gaps and compression of insulation. The presence of voids within the insulation results in energy loss and facilitates the development of moisture due to the disparity in temperature between the insulation and the surrounding ambient air. It should be noted that fiberglass or cellulose or other batt insulation that fills wall cavities acts as a barrier around box 100.

When box 100 is mounted to a stud on a 2×4 wall, the bottom is positioned approximately 1″ away from the external wall, increasing its exposure to the exterior wall where it is subject to cold and warm air transfer. Utilizing fiberglass insulation between box 100 and exterior wall can supply an R3 of insulation value where spray foam sealant transported through box 100 would yield a R9 value. Box 100 must occupy wall space that cannot be insulated and approximates the outside wall which is exposed to the weather elements.

Sheetrock or drywall is commonly utilized as interior sheeting in building construction and is customarily from ½ to ⅝ths of an inch thick. Box 100 is mounted on a stud with top projecting ½ inch forward of stud. Sheetrock is cut using a saw or rotary zip tool to allow box 100 to be flush to the top of sheetrock and approximate with top 114. The saw blade or rotary zip drill bit is ⅛^{th} inch diameter. After sheetrock is installed, Box 100 has the equivalent of 20 inches of outer perimeter that will have ⅛^{th} inch opening between the sheetrock and box 100. This surface area is equivalent to a one-inch open hole that permits air flow in and out of the internal building envelope. Wire knockouts 126 features an open periphery 128 that allows for electrician to ‘knockout’ if wire is planned to enter box 100 at that location. There are instances where an electrician may knock out but not use, or the open periphery in and of itself permits air to flow in and out of box 100. Since the wire is smaller in diameter than the knockouts, there is sufficient space for air circulation in and out of box 100. This also allows for visual inspection through Box 100 both open and unopened knockouts, as well as behind box 100 after the sheetrock has been installed.

It should be known that by virtue of wires being connected in circuits inside wall cavities, enhances the air flow and pressure changes between the boxes. Eliminating this transmission and air flow is an object of our invention.

Air Pressure changes in homes and buildings are created by doors opening and closing allowing air to flow freely from box 100 through walls and in and out of other boxes pulling fiberglass, allergens, mold, dust and other pollutants into the living space, before box 100 is insulated and air sealed with spray foam sealant insulation, which is an object of this invention. Furthermore, electrical boxes or rounds on ceilings have the greatest capability of allowing fiberglass or cellulose fibers to enter the living space through knockouts due to the vantage point at top of ceiling.

After the walls are insulated and before the interior wall drywall or sheeting is applied, a plastic sheeting or vapor barrier is installed to keep moisture from penetrating into the living space. This is often in the form of plastic sheeting. Box 100 penetrates this sheeting or vapor barrier through its periphery. Furthermore box 100 has created problems with uniform insulation and vapor barrier, due to the varying positions of wires and compression of fiberglass insulation, open wire knockouts, the disruption of continuous plastic sheeting in which effects the vapor barrier and home envelope.

According to this embodiment box 100 has a busses channel 130 with the capability of transferring a flowable, curable foam sealant through the box for vapor sealing and insulating around box 100. The foam sealant follows the path of least resistance as it exits the foam sealant transfer channel 136, effectively filling voids in the insulation within the enclosed wall cavity without causing any deformation to the interior wall finishes.

The procedure of utilizing box 100 for air sealing and insulation behind a sheeted wall is as follows; A sprayed flowable, curable foam sealant should be utilized that has a low expansion quality. One example of this is Great Stuff brand Window and Door Foam sealant. The low expansion qualities eliminate the distortion of the building components as the foam sealant finds its path of least resistance through the voids and between the wires around box 100. A can of spray foam sealant is typically attached to a foam sealant dispenser, which features a mechanism that dispenses the foam sealant using a pulling action by a trigger or a lever. Great Stuff brand, for example, has a patented dispenser called the Smart Dispenser, that has a cone shaped tip; however they and other brand foam sealants also have foam sealant dispensers that have a dispenser in the shape of a tube or straw. Tubes may have a measurement that varies from 6/32″ to 9/32″ and the patented Smart dispenser has a measurement of 6/32″, which is much greater in diameter that the 4/32″ screw receptacle of box 100. Adapters of all shapes and sizes may further be attached to existing dispensers, thus the foam sealant dispenser receptacle 132 may be of any shape and size or also may be absent.

To insulate and vapor seal box 100 through boss channel 130, all safety protocols regarding the utilization of spray foam sealant including safety glasses, safety gloves and other protocols recommended by the manufacturer should be implemented. The installer must place the tip 202 of dispenser tube 200 firmly into front aperture of boss channel 130 to maintain an airtight seal. This seal or friction fitting will allow for rapid foam sealant transfer and prevents foam sealant from leaking around the tip of the applicator and box 100 and flowing into box 100 or onto the living space. While the installer is holding the tip firmly against box 100 they are visually looking through the inside of box 100 and particularly at the wire knockout periphery 128 or through open wire knockout 126. The user then depresses the foam sealant applicator to disperse the flowable, curable foam sealant until foam sealant is visually present at the knockouts 126 (such as for about 2 seconds) at which time the foam sealant dispensing should be stopped. As the foam sealant enters boss channel 130 of box 100 it will flow through screw receptacle 134, and continue to flow into foam sealant transfer channel 136 (if present), from which it will exit boss channel through opening 150 and, in the embodiment shown in FIGS. 1-4, and at least partially into trough 138. In the embodiment shown in FIGS. 1-4, boss channel 130 is about 2 inches long and opening 150 is located on end sidewall 118 at a distance from open face 114 equal to about 50% of the depth of the box, however other embodiments are imagined. As foam sealant exits foam sealant transfer channel 136, it will begin to expand in all directions and take the path of least resistance around the box. Because foam sealant is traveling into a specific plane along the boss channel 130, some foam sealant will continue into the same plane through trough 138 and continue to the bottom of box 100. Foam sealant that exits foam sealant transfer channel 136 will also travel upwards and be forced to the side of box 100, that is opposite of the stud that box 100 is attached to. As foam sealant exits foam sealant transfer channel 136 the foam sealant will expand against the surrounding insulation. It should be apparent that fiberglass insulation has many small fibers that are bonded together that will prevent foam sealant from penetrating great distances inside the insulation but will force the foam sealant against the boxes entire periphery as it forms an enclosure around the box. The fiberglass insulation forms a barrier around the entire box and acts as a barrier structure and forces the foam sealant around the entire periphery of the box 100. As foam sealant exits boss channel 130 of box 100, foam sealant will expand around box 100 and bond to the back of the interior wall sheeting. Foam sealant will then bond box 100 to the fiberglass insulation and to the back of the interior wall sheeting and bond all three components together into a single airtight and insulated box.

Opening 150 preferably is located at a distance from open face 114 at least 25% of the depth of box 100 or foam sealant exiting opening 150 would adversely only travel above, below or between insulation and the backside of interior wall sheeting, which then would create a void at front wall between the sheeting and the insulation, and would fail to reach the back, sides or bottom or top of the box, thus increasing the chances of energy loss. In addition, if opening 150 is located at a distance from open fact 114 less than 25% of the depth of box 100, foam sealant exiting opening 150 will travel up the front of the wall between the interior sheeting and push fiberglass away from the wall, thus increasing energy loss.

FIGS. 1-4 show a preferred embodiment in which multiple (two in this particular embodiment) bosses 102 having boss channels 130 are present on opposing end sidewalls 118 of box 100. In such embodiments, foam sealant may be introduced through only one of boss channels 130 or through multiple boss channels 130. In such cases, after the foam sealant is introduced into and passes through one of boss channels 130, the installer may move to the next boss channel 130 and repeat the same process. If foam sealant is not visible through wire knockouts 126 or the wire knockouts periphery 128, the process should be completed again with additional single second bursts of foam sealant until foam sealant is visible through the wire knockouts 126 or wire knockout periphery 128. If boss channels 130 are overfilled, and foam sealant enters the box 100 through wire knockouts 126 or is inadvertently sprayed inside box 100, it should be removed after the foam sealant is dried. All foam sealant should be removed from the inside of the box. Three safety measures that will prevent foam sealant from being left inside the box include; proper instructions and protocols, licensed electricians who are educated about removing foreign objects from the box, and inspectors who are trained to identify these potential problems. The described process of insulating and air sealing box 100 is performed before fixture 140 is installed. This requires the electrician to pull out the wires and inspect the inside of the box 100 before fixture 140 is wired and power is turned on.

Although some residual foam sealant may be left in screw receptacle, its consistency is minor and helps retain fixture screw from loosening as the foam sealant assists in bonding screw within box, which is an object of this invention.

It is an object of our invention to provide calculated amounts of foam sealant simultaneously to all areas around the box.

Referring to FIGS. 5 and 6 box 700 has a bottom 112, continuous sidewall 702, wire knockouts 126 and knockout periphery 128 (only one numbered) and bosses 102 are positioned symmetrically at opposite sides. The top face of bosses 102 is recessed bottomward of open face 710 of box 700 by a distance approximately 4/32″ (about 3 mm), however, the top face of bosses 102 may be recessed by other distances, such as 2/32 (about 1.5 mm) to 12/32″ (about 9.5 mm) accordingly in other embodiments and may not be recessed at all. Nail brackets 604 are shown in FIG. 5 and removed in FIG. 6 for demonstration purposes. It should be noted that bosses 102 occupy valuable space inside box 700 and all embodiments of this invention. Bosses 102 form a trough 138 that is apparent from the outside appearance of box 700 and a tubular-like structure that is visible from the inside of box 700. Each boss 102 has a boss channel 130, as generally described before, and in addition has a separate screw receptacle 706. As shown in FIGS. 5 and 6, each boss channel 130 includes an optional foam sealant dispenser receptacle 132, a screw receptacle 134 an opening 150 and optional trough 138, all as described before. Boss channels 130 may also include an enclosed extended channel as described before. The presence of both both channels 130 and separate screw receptables 706 permit box 700 to accommodate multiple sized fixtures and embodiments and may realize multiple bosses 102 in any arrangement in different embodiments. As shown, standard screw receptacles 706 are positioned outside screw receptacles 134, do not include a boss channel 130 described as having three distinct parts being an optional foam sealant dispenser receptacle 132, screw receptacle 134 and foam sealant transfer channel 138, in this embodiment, however those elements may be present in other embodiments. The pair of screw receptacles positioned at the inner most portion of bosses 102, are visible on side view FIG. 6 as having a conical shaped foam sealant receptacle that is 8/32″ (6.35 mm) and a screw receptacle channel which is 6/32″ (about 4.75 mm) in diameter and a trough 138 that extends to the back 112 of box 700. In embodiment 700 wire knockouts 126 are positioned on bottom wall 112, however embodiments are realized where knockouts are positioned on side 702. In these embodiments boss channel 130 may not extend clear to the bottom wall 112 and may be strategically placed above locations where wire knockout 126 and is located at sides 702. In other embodiments both pairs of screw receptacle channel 132, 706, may be utilized as boss channel 130 and yet other embodiments may have multiple boss channels 130 in different locations.

Round box applications are used in walls and often in ceilings of building structures so it should be obvious that transferring foam sealant through box 700 through boss channel 130 would project foam sealant over bottom 112 of box 700 and insulate and air seal wire knockouts 126 or to project foam sealant at sidewall 702. Trough 138 may be have a geometry as described before to further direct foam sealant over wire knockouts 126.

It should be apparent that embodiments may contain bosses with larger screw receptacles enough to accommodate foam sealant dispensers, thus embodiments exist that do not require a foam sealant receptacle 132 yet include an enclosed extended channel 136 for the transfer of foam sealant rearward from the front of the box.

It should be apparent that bosses 102 in embodiment 700 occupies internal space of its tubular form with its need to hold fixtures and assumes a trough like structure on the outside periphery.

The invention represents a significant advancement in electrical box technology by overcoming several limitations of current solutions. Conventional electrical boxes have many problems which include puncturing the home vapor barrier or envelope, allowing cold and warm air transfer from the exterior elements, allowing entry of pests and dust, allergens and pollutants.

This invention features innovative design with an improved screw receptacle opening to allow for greater ease of installing various fixture screws during assembly, an improved boss channel and foam sealant dispenser receptacle that accepts various foam sealant straws, foam sealant dispensers and foam sealant guns. The boss channel is leveraging existing molds and shapes but enhancing its performance to allow the foam sealant to transfer rearward, above and below the box to fill voids and problem areas in the home envelope. In addition, to seal up the open peripheries of these box knockouts that may or may not contain wire, this invention dramatically improves the insulation, seal and reduces

A key advantage of this invention is its integration with a foam sealant application system. Using a foam sealant dispenser, the invention allows for efficient sealing of gaps around the electrical box. This not only contributes to better air sealing and insulation but also helps in reducing dust, allergens, and pollutants entering the box which then enter the home living environment, addressing concerns related to indoor air quality and pest control.

Functionally, the invention's design allows for a range of wiring configurations and applications, making it versatile and suitable for various settings. The use of foam sealant enhances the overall functionality by improving thermal insulation, vapor seal and soundproofing, which further benefits the user by enhancing comfort and energy efficiency. By bonding all materials together within the wall cavity, it strengthens the electrical box as well.

In terms of market applicability, the invention is poised to serve both residential and commercial sectors, offering versatility and superior performance. Economically, it provides potential cost savings through reduced installation time, energy expense, while also creating opportunities for new revenue streams by meeting the growing demand for advanced construction solutions.

Additionally, the box is made from fire-resistant materials, maintaining the wall assembly's fire safety without compromising insulation and sealing. Despite these advanced features, the box is designed for easy installation, compatible with various wall types and standard mounting options. This improved electrical box is particularly suited for energy-efficient buildings, where reducing energy loss and maintaining indoor air quality are critical.

Overall, the invention's unique combination of advanced functionality, increased energy efficiency, and cost benefits establishes it as a highly valuable and market-ready solution.

In summary, the invention is an electrical junction box that may be of any shape and comprises a box with a bottom, one or more sidewalls, and an open face opposite the bottom. This box defines an interior space, with one or more wire entry points through either the sidewalls or bottom. The junction box is equipped with fastening means for attachment to a construction assembly. A boss is positioned on one or more sidewalls inside the box, featuring a channel designed to hold a foam sealant dispenser. This boss channel connects to an opening in the sidewall or bottom, allowing fluid communication through a flow path that extends from the foam sealant dispenser receptacle, through a recessed screw receptacle, and out of the box. The box may also feature additional bosses and channels, all designed to facilitate the introduction of a flowable, curable foam sealant into the surrounding space during installation, thus sealing the box. The associated method involves affixing the box to a construction assembly, introducing foam sealant via the foam sealant dispenser receptacle, and curing the foam sealant to provide a sealed enclosure. The design further allows for the installation of electrical components by inserting screws into the recessed screw receptacles after the foam sealant has cured.

The present disclosure relates to various embodiments of an electrical junction box and associated methods of use. While specific embodiments and features of the invention have been described in detail, it should be understood that these embodiments are provided by way of example, and the invention is not limited to these particular forms. Modifications, substitutions, and variations can be made without departing from the scope of the invention as claimed. For example, the junction box may take different shapes, sizes, and configurations, and the materials used may vary depending on the intended application or environment. Additional elements, such as different fastening means, wire entry points, or boss configurations, may be utilized to achieve similar functionality. Furthermore, the described methods of sealing the box and installing components may be adapted or modified to suit other construction or installation techniques. Accordingly, all such variations and equivalent arrangements are intended to fall within the scope of the claims and the invention as broadly described and envisioned.

### DRAWING KEY

100. Box
102. Bosses
106. Screw Receptacle Channel
108. Extended Electrical Channel
112. Bottom Wall
114. Open Face
116. Lateral Sidewalls
118. End Sidewalls
120. Nail Flange
126. Wire Knockout
128. Wire Knockout Periphery
130. Boss channel
132. Foam sealant Dispenser Receptacle
134. Screw Receptacle
136. Enclosed Extended Channel
138. Trough
140. Electrical Fixture (Outlet, Switch, Etc)
144. Fixture Screw
150. Opening
160. Front Aperture
170. Trough Bottom
200. Dispenser Tube
202. Dispenser Tip
604. Nail bracket
700. Box
702. Continuous Sidewall
710. Open Face

1. An electrical junction box of any shape, which comprises
a box having a bottom wall, one or more sidewalls, and an open face opposing the bottom wall; the bottom wall and one or more sidewalls defining an interior space having a depth from the open face to the bottom,
one or more wire entry points through a sidewall or bottom wall; and
a boss positioned on the one or more sidewalls, the boss having a boss channel, the boss channel comprising a foam sealant dispenser receptacle having a front aperture open to the open face and a recessed screw receptacle exposed to the open face through the foam sealant dispenser receptable, wherein the boss channel is in fluid communication with an associated opening in the sidewall or the bottom wall, the boss channel defining a flow path from the foam sealant dispenser receptacle through the recessed screw receptacle and out of the box through the associated opening, and the front aperture of the foam sealant dispenser receptacle has a diameter larger than the diameter of the recessed screw receptacle.

2. The electrical junction box of claim 1, wherein the boss channel further comprises an enclosed foam sealant transfer channel in fluid communication with the recessed screw receptacle and the associated opening in the sidewall or the bottom wall, the boss channel defining a flow path from the front aperture of the foam sealant dispenser receptacle through the foam sealant dispenser receptacle, the recessed screw receptacle, and then the enclosed foam sealant transfer channel and out of the box through the associated opening.

3. The electrical junction box of claim 1, wherein at least a portion of the enclosed foam sealant transfer channel has a larger diameter than the diameter of the recessed screw receptacle.

4. The electrical junction box of claim 1, wherein the associated opening is positioned on a sidewall at a distance from the open face of at least 25% of the depth of the box.

5. The electrical junction box of claim 4, wherein the associated opening is positioned on a sidewall at a distance from the open face of at least 50% of the depth of the box.

6. The electrical junction box of claim 4, wherein the associated opening in the sidewall is in fluid communication with a trough on an exterior side of the sidewall, the trough extending from the associated opening to the bottom of the box.

7. The electrical junction box of claim 6, wherein the trough has a trough bottom and an opening to the exterior surface of the sidewall, and the trough is wider at the opening to the exterior surface of the sidewall than at the trough bottom.

8. The electrical junction box of claim 7, wherein the trough has a generally v-shaped cross-section and has a width that increases from the associated opening to the bottom of the box.

9. The electrical junction box of claim 6, wherein the associated opening is positioned on a sidewall at a distance from the open face of at least 50% of the depth of the box.

10. The electrical junction box of claim 1 further comprising a second boss positioned on the one or more sidewalls and spaced part from the first boss, the second boss having a second boss channel, the second boss channel comprising a second foam sealant dispenser receptacle having a front aperture open to the open face and a second recessed screw receptacle exposed to the open face through the foam sealant dispenser receptable, wherein the second boss channel is in fluid communication with an associated opening in the sidewall or the bottom wall, the second boss channel defining a flow path from the second foam sealant dispenser receptacle through the second recessed screw receptacle and out of the box through the associated opening, and the front aperture of the second foam sealant dispenser receptacle has a diameter larger than the diameter of the second recessed screw receptacle.

11. The electrical junction box of claim 10 wherein the second boss channel further comprises a second enclosed foam sealant transfer channel in fluid communication with the second recessed screw receptacle and the second associated opening in the sidewall or the bottom wall, the second boss channel defining a flow path from the front aperture of the second foam sealant dispenser receptacle through the second foam sealant dispenser receptacle, the second recessed screw receptacle, and then the second enclosed foam sealant transfer channel and out of the box through the second associated opening in fluid communication with the second foam sealant transfer channel.

12. The electrical junction box of claim 1 wherein the front aperture of the foam sealant dispenser receptacle has a diameter of 6/32″ to 8/32″ and the foam sealant dispenser receptacle has a depth of 4/32″ to 16/32″.

13. An electrical junction box of any shape, which comprises
a box having a bottom wall, one or more sidewalls, and an open face opposing the bottom wall; the bottom wall and one or more sidewalls defining an interior space having a depth from the open face to the bottom wall,
one or more wire entry points through a sidewall or bottom wall; and
a boss positioned on the one or more sidewalls, the boss having a boss channel, the boss channel comprising a foam sealant dispenser receptacle having a front aperture open to the open face and a screw receptacle exposed to the open face through the foam sealant dispenser receptable, wherein the boss channel is in fluid communication with an associated opening positioned on the sidewall at a distance from the open face of at least 25% of the depth of the box, the boss channel defining a flow path from the foam sealant dispenser receptacle through the screw receptacle and out of the box through the associated opening, wherein the associated opening in the sidewall is in fluid communication with a trough on an exterior side of the sidewall, the trough extending from the associated opening to the bottom of the box.

14. The electrical junction box of claim 13, wherein the trough has a trough bottom and an exposed surface on an exterior surface of the sidewall, and the trough is wider at the exposed surface than at the trough bottom.

15. The electrical junction box of claim 14, wherein the trough has a generally v-shaped cross-section and has a width that increases from the associated opening to the bottom of the box.

16. A method of sealing an electrical junction box, comprising
a) fastening an electrical junction box of claim 1 onto a construction assembly such that the electrical junction box is at least partially surrounded by empty space;
b) introducing a flowable, curable foam sealant into the foam sealant dispenser receptacle and flowing the foam sealant through the boss channel and out of the associated opening into the empty space at least partially surrounding the electrical junction box, and
c) curing the foam sealant in the space surrounding the electrical junction box.

17. The method of claim 16 wherein step b) is performed by inserting a tip of a foam sealant dispenser into the front aperture of the foam sealant dispenser receptacle and dispensing the foam sealant from the foam sealant dispenser into and through the boss channel and out of the associated opening into the empty space at least partially surrounding the electrical junction box.

18. A method of sealing an electrical junction box, comprising
a) fastening an electrical junction box of claim 13 onto a construction assembly such that the electrical junction box is at least partially surrounded by empty space;
b) introducing a flowable, curable foam sealant into the foam sealant dispenser receptacle and flowing the foam sealant through the boss channel and out of the associated opening into the empty space at least partially surrounding the electrical junction box, and
c) curing the foam sealant in the space surrounding the electrical junction box.

19. The method of claim 18, further comprising, prior to step b), inserting a wire into the electrical junction box through an opening created by removal of a wire knockout and, after step c), a step of d) fastening an electrical component in the box by inserting a screw into the screw receptacle.

20. A method of sealing an electrical junction box, comprising
a) fastening the electrical junction box onto a construction assembly mounted onto a construction assembly such that the electrical junction box is at least partially surrounded by empty space,
wherein the electrical junction box comprises a box having a bottom wall, one or more sidewalls, and an open face opposing the bottom wall; the bottom wall and one or more sidewalls defining an interior space having a depth from the open face to the bottom wall; one or more wire entry points through a sidewall or bottom; a boss positioned on the one or more sidewalls, the boss having a boss channel having a front aperture open to the open face, wherein the boss channel is in fluid communication with one or more associated openings in the sidewall or the bottom wall, the boss channel defining a flow path from the front aperture to the associated opening;
b) introducing a flowable, curable foam sealant into the boss channel through the front aperture and flowing the foam sealant through the boss channel and out of the associated opening into the empty space at least partially surrounding the electrical junction box, and
c) curing the foam sealant in the space surrounding the electrical junction box.
